(19) United States
(12) Patent Application Publication
(10) Pub. No.: US 2018/0022125 A1
(43) Pub. Date: Jan. 25, 2018

(54) PRINTER WITH HEIGHT ADJUSTABLE PRINT HEAD

(71) Applicant: Océ-Technologies B.V., Venlo (NL)

(72) Inventors: Patrick G.H. VESTJENS, Venlo (NL); Jacobus J. KANDELAARS, Venlo (NL); Joost H.H. VAN PINXTEN, Venlo (NL)

(73) Assignee: Océ-Technologies B.V., Venlo (NL)

(21) Appl. No.: 15/722,803

(22) Filed: Oct. 2, 2017

Related U.S. Application Data
(63) Continuation of application No. PCT/EP2016/057394, filed on Apr. 5, 2016.

(30) Foreign Application Priority Data
Apr. 10, 2015 (EP) 15163126.4

(51) Int. Cl. B41J 25/308

(52) U.S. Cl. CPC B41J 25/308

(57) ABSTRACT

A printer that is adapted for printing on a mixed sequence of media sheets with a print head that is adjustable in height relative to a print surface that supports the media during printing, the printer having a user interface (34) and a controller, wherein the controller stores a set of different height adjustment strategies for handling media that differ in specifications that define an admissible range for the height of the print head, and the user interface is adapted to permit the user to select among the stored height adjustment strategies.

### BACKGROUND

The present invention relates to a printer that is adapted for printing on a mixed sequence of media sheets with a print head that is adjustable in height relative to a print surface that supports the media during printing, the printer having a user interface and a controller arranged to control a height adjustment mechanism for the print head.

In many printers, e.g. in ink jet printers, the print head is disposed at a short distance above the surface of the media sheets that are supported on a print surface, e.g. on a conveyer belt, a platen or the like. For simplicity, the term “height” is used here to define the distance, in a direction normal to the print surface, between the print surface and a surface of the print head that faces the print surface, and it is assumed that the print head is disposed “above” the print surface, although the present invention is not limited to printers where the print surface is oriented horizontally.

In order to obtain a high print quality, it is desired that the distance between the print head and the surface of the media sheets is as small as possible. For example, in an ink jet printer a small distance between the print head and the media sheet is desired in order to minimize the distance that the ink droplets have to travel, and thereby to minimize the amount of aberration of the ink droplets. On the other hand, the print head must of course not collide with the media sheets, so that there should always be a certain safety distance between the surface of the sheets and the print head. This safety distance depends upon the thickness tolerances of the media sheets, their tendency to cockle or to form wrinkles and the like, so that a lower limit of the admissible range for the height of the print head is derivable from the specifications of the individual types of media sheets. The upper limit of this admissible range may also depend upon the media type, because certain properties of the media sheet such as their capability to permit the ink droplets to spread over the sheet surface and/or to absorb ink in the interior of the sheet material have an influence on the tolerable aberration of the ink droplets and consequently on the distance that the ink droplets have to travel.

The media types that are to be used for printing are specified in the print job or print jobs that are to be processed with the printer. The media type may not only vary from print job to print job, but even a single print job may specify that different media types are to be used for different pages of the document to be printed. Consequently, there may be cases where a mixed sequence of media sheets of different types is scheduled for printing. In that case, depending upon the thickness of the different media sheets and on the media specifications, it may be necessary to change the height adjustment of the print head in the interval between the printing periods for two successive sheets.

As the height adjustment of the print head as well as cleaning of the print surface takes a certain amount of time, considerable losses in productivity may occur when the height of the print head has to be re-adjusted frequently.

The losses in productivity are particularly pronounced in duplex printing. In a typical duplex printer, the duplex loop accommodates a plurality of sheets, so that a set consisting of a certain number of sheets is moved past the print head a first time for printing an image on the first side of the sheets, and then these sheets will be returned via the duplex loop and will be moved past the print head a second time in order to form an image on the second side. When this set of sheets contains different media types, each adjustment operation of the print head that has been performed during printing on the first side of the sheets has to be repeated when these sheets return from the duplex loop.

A printer according to the preamble of claim 1 is disclosed in US 2004/047665 A1.

EP 0 516 283 A2 discloses a printer wherein the user can choose between automatic and manual height adjustment of the print head.

It is an object of the present invention to propose a printer that permits to mitigate the productivity losses in printing on mixed media.

### SUMMARY

In order to achieve this object, according to the present invention, the controller stores a set of different height adjustment strategies for handling media that differ in specifications that define an admissible range for the height of the print head, said height adjustment strategies being different from one another in that they permit each a different productivity of the print process, and the user interface is adapted to permit the user to select among the stored height adjustment strategies.

In this way, the user has the option to select between a height adjustment strategy that permits a high print quality but may not be optimal in terms of productivity and another strategy that will provide an acceptable but possibly not always optimal print quality but permits a substantial gain in productivity by reducing the number of height adjustment operations to be performed.

More specific optional features of the present invention are indicated in the dependent claims.

The height adjustment strategy may for example comprise a strategy “adjust on demand” in which a height adjustment operation will be performed only when the current height of the print head is outside of the admissible range for the next sheet to be printed. According to that strategy, a height adjustment operation is omitted when the current height is still in the admissible range for the next sheet, although it may not be optimal for that sheet. Consequently, the number of height adjustment operations is reduced, and the productivity is increased accordingly.

Another one of the selectable height adjustment strategies may comprise the steps of:

(a) retrieving admissible height ranges for a plurality of media sheets that are scheduled for printing,
(b) searching for a height value that is contained in the admissible range of all scheduled sheets,
(c1) if such a height value is found, adjusting the print head to that height value,
(c2) if not, proceeding to a problem handling routine.

When this strategy is selected, at least in the cases where an overlap exists between the admissible height ranges for all the sheets, the print head is adjusted to a height value within this overlap, so that the entire sequence can be printed without having to adjust the height of the print head in-between. Nevertheless, the distance between the print head and the surface of the sheets will always be within a tolerable range, so that a consistent and required print quality can be achieved. When a high print quality is required the print head is preferably adjusted to a minimum height value within the overlap.

Only in cases where the sheets are so different from one another that there exists no height value that is contained in the permissible height ranges of all media types involved, it will be necessary to proceed to a specific routine for dealing with the problem of incompatible height ranges, e.g. by proceeding with printing in the usual way with height adjustments of the print head where necessary, although on the cost of productivity.

In one embodiment, the problem handling routine may comprise or consist of a step of alerting the user that a certain loss in productivity has to be expected. Optionally, the productivity loss may be quantified on the basis of the number of necessary height adjustments.

In addition to a productivity alert, the problem handling routine may also comprise a step of proposing to the user to replace at least one of the media types that have been specified in the print job by another one in order to make the admissible height ranges compatible and thereby to improve the productivity.

In another embodiment, the problem handling routine may comprise a step of adjusting the print head to a height value that is safe for all media types involved but may be larger than the upper limit of the admissible range for at least one media type, and alerting the user that certain losses in print quality have to be expected. Optionally, these losses may also be quantified on the basis of the extent to which the selected height value exceeds the upper limit of the admissible range.

In yet another embodiment, the problem handling routine may comprise a step of dividing the sequence of sheets that are scheduled for printing into two contiguous sub-sequences and then trying to find a height value that fits in all admissible ranges at least within the respective sub-sequences. In that case, only a single height adjustment operation will be necessary during the time in which the entire sequence is printed. In case that no suitable height value can be found neither for one or both of the reduced sub-sequences, the procedure may be iterated. The iteration will come to an end at the latest when the sequence has been divided so often that each sub-sequence consists only of a single sheet. In any case, this iteration will minimize the number of necessary height adjustment operations.

It is also possible to select among the different versions of problem handling routines that have been outlined above. The selection may depend upon the results of the preceding steps. For example, when it is found that the productivity loss would be substantial but could be largely avoided when one of the specified media types is replaced by a very similar other media type, then it will be appropriate to propose a change of the media type rather than accepting a loss in print quality or trying to split the sequence. On the other hand, when it is found that the expected loss in print quality would not really be significant, it would be appropriate to decide in favour of productivity rather than quality.

### BRIEF DESCRIPTION OF THE DRAWINGS

Embodiment examples will now be described in conjunction with the drawings, wherein:

FIG. 1 is a schematic view of an ink jet printer to which the present invention is applicable;

FIG. 2 shows a screen displayed on a user interface of the printer;

FIG. 3 is a diagram illustrating a mixed sequence of media sheets and an example of a height adjustment strategy for a print head of the printer;

FIG. 4 is a diagram illustrating the mixed sequence of media sheets, related admissible ranges for the height of the print head, and another example of a height adjustment strategy;

FIGS. 5 to 12 are diagrams similar to FIG. 4 and illustrate different height adjustment strategies; and

FIG. 13 is a flow diagram illustrating essential steps in one of the height adjustment strategies.

### DETAILED DESCRIPTION

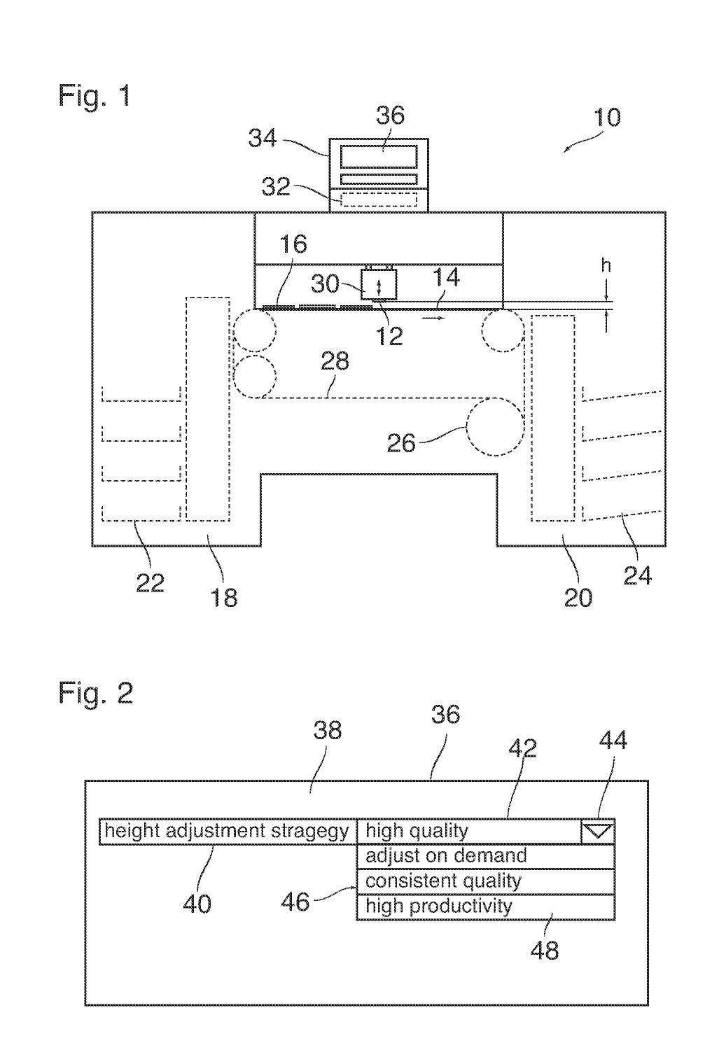

FIG. 1 shows an example of an ink jet printer 10 comprising a print head 12 that is disposed closely above a print surface 14 and arranged to scan the print surface in the direction normal to the plane of the drawing in FIG. 1.

In this example, the print surface 14 is formed by a conveyer belt arranged to advance a sequence of media sheets 16 from a feed section 18 of the printer past the print head 12 and to a discharge section 20. The feed section 18 includes a plurality of trays 22 for storing stacks of media sheets of different types and is arranged to feed the media sheets of the different types to the print surface 14 in a mixed sequence, depending on media selections that are specified in a print job, as is generally known in the art. The discharge section 20 contains a plurality of discharge bins 24 to which the printed copies are fed in a collated manner.

A sheet reversal mechanism 26 and a duplex loop 28 are provided for returning a collection of the sheets 16, on which an image has been printed on the first side, in reversed orientation back to the entry side of the print head for printing another image on the second side.

A height adjustment mechanism 30 is provided for adjusting the height h of the print head 12, more precizely, the height of a bottom face (the nozzle face) of the print head relative to the print surface 14. In this way, the distance that ink droplets ejected from the nozzle face of the print head have to travel before they reach the top surface of the media sheets 16 can be set to a value that assures a high print quality, even when the thickness of the media sheets varies.

The various functions of the printer 10, including the operation of the print head 12, the feed section 18 and the height adjustment mechanism 30 are controlled by an electronic controller 32 that includes also a scheduler for scheduling the sequence in which in the media sheets of different types are withdrawn from the trays 22 and fed to the print surface in accordance with the instructions in the print job. A user interface 34 including a display 36 is provided for permitting a user or operator to enter operating instructions and for displaying messages to the user or operator.

When the media sheets that are scheduled for printing are all of the same type, the print head 12 may be adjusted to a suitable height h, and then the media sheets may be moved past the print head in rapid succession without stopping the conveyer and with only small intervals between the successive sheets. However, when the sequence contains media sheets of different types, it may be necessary to adjust the height h of the print head when one sheet has been printed and before the next sheet reaches the print head. In that case, in order to provide sufficient time for the height adjustment of the print head, it is necessary to either stop the conveyer temporarily or to provide larger gaps between the successive media sheets. In any case, more time will be needed for completing the print process, so that the productivity of the printer decreases.

The duplex loop 28 is capable of accommodating a certain maximum number of media sheets. Consequently, in a first case, the sequence of sheets that are scheduled for printing is divided into a plurality of batches each of which contains not more than the maximum number of sheets that the duplex loop can accommodate, and the supply of the sheets will be controlled such that batches in which an image is printed on the first side of the sheets alternate with batches in which an image is printed on the second side of the sheets that have been returned via the duplex loop. When such a batch contains at least one sheet that requires a re-adjustment of the height h of the print head, it is necessary to perform at least two height adjustment operations, one when the batch is processed the first time and one when it is processed a second time after it has returned from the duplex loop. Consequently, productivity losses are particularly severe in duplex printing. In a second case, duplex printing is established in an interweaving mode where empty sheets alternate with sheets that have already been one sided printed. In the interweaving mode, the sequence of sheets may be interweaved in such a way that the number of height adjustment operations is reduced by scheduling sheets having the same height requirement next to each other when merging the two sheet streams in the duplex loop.

Different height adjustment strategies are conceivable for adjusting the height of the print head, and these different strategies will typically involve a certain trade-off between productivity and print quality. For this reason, the controller 30 and the user interface 34 of the printer shown in FIG. 1 provide an option permitting the user to select among different height adjustment strategies and in particular to select between a strategy that gives a higher priority to print quality and a strategy that gives higher priority to productivity.

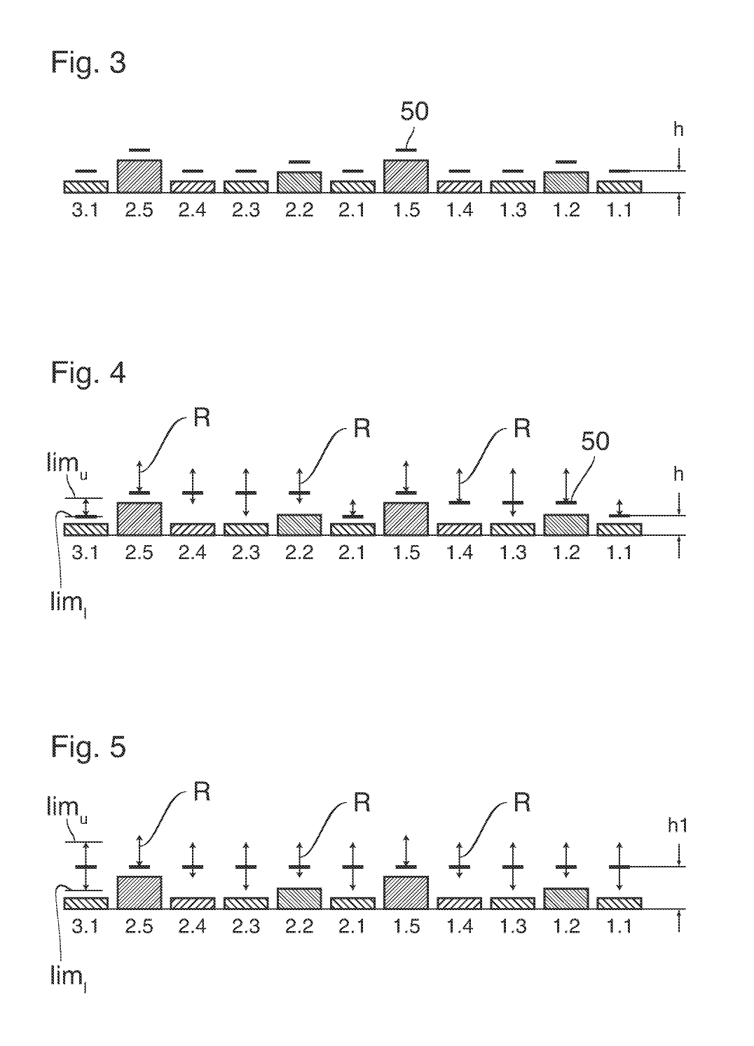

FIG. 2 shows an example of a screen 38 to be shown on the display 36 of the user interface. The screen 38 includes (among other items which have not been shown here) a menu point 40 “height adjustment strategy” and a field 42 indicating a height adjustment strategy that has currently been selected. In this example, the selected strategy is named “high quality”. Clicking on a button 44 causes a selection menu 46 to pop up. This selection menu includes a set of several (four in this example) pre-defined height adjustment strategies 48 among which the user may select. These selectable strategies are named “adjust on demand”, “consistent quality”, “high productivity” and “high quality”.

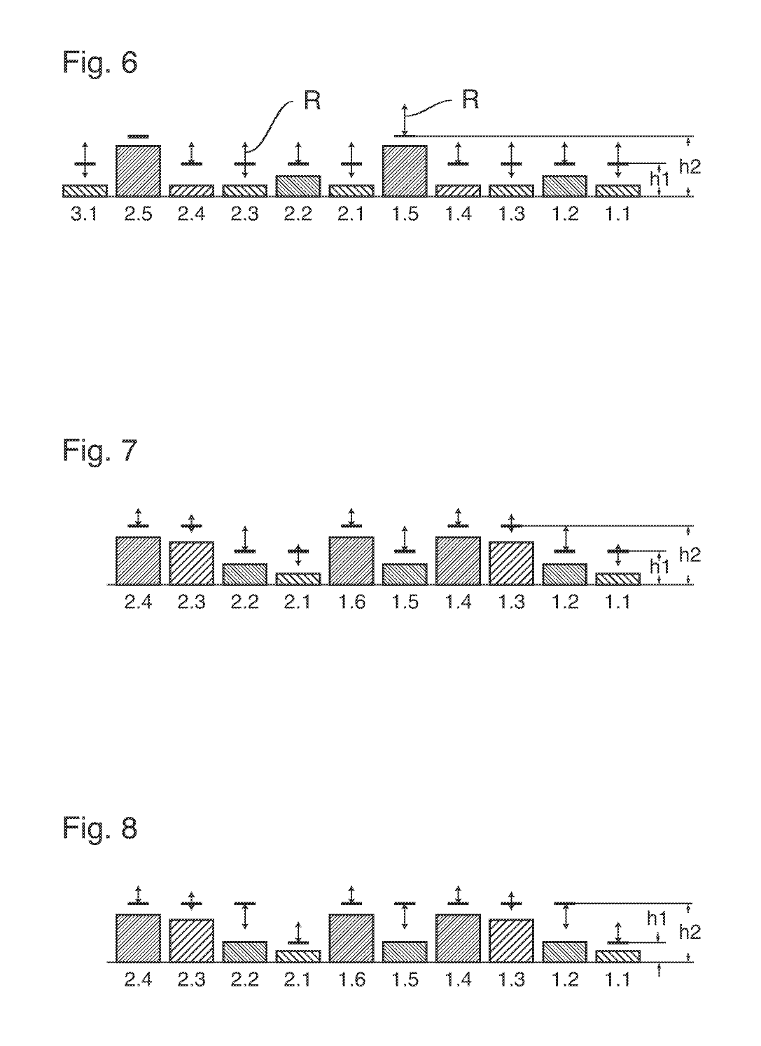

The strategy “high quality” will be explained by reference to FIG. 3.

FIG. 3 is a diagram illustrating a printing method for processing a print job that consists in printing several copies of a five page document (simplex printing). The hatched rectangles in FIG. 3 symbolize the media sheets arranged in the sequence (from right to left in FIG. 3) in which they are scheduled for printing. Thus, sheet 1.1 is a sheet that is to form the first page of a first copy of the document, the sheets 1.2-1.5 are intended to become pages 2 to 5 of the first copy, sheet 2.1 is intended to become the first page of the second copy of the document, and so on.

In the example shown, the media types of the sheets 1.1-3.1, as specified in the print job, differ in thickness (as symbolized by different heights of the rectangles in FIG. 3), and they also differ in material or coating, as symbolized by different hatchings of the rectangles in FIG. 3. A bar 50 above each of the rectangles that symbolize the media sheets indicates the height h to which the print head is adjusted for printing on the respective sheet.

According to the selected strategy “high quality”, the height h depends on the thickness of the sheets and is selected such that the distance between the nozzle of the print head to the top surface of the sheet is constant and corresponds to the minimum safety distance that should be provided between the sheet and the print head. This assures that the aberration of the ink droplets is reduced to a minimum, but has the consequence that the height “h” of the print head must be adjusted frequently. In the example shown, as many as four height adjustment operations are necessary for each copy of the 5-page document (after printing sheet 1.1, after printing sheet 1.2, after printing sheet 1.4 and again after printing sheet 1.5).

In the example shown, the minimum safety distance is selected to get a high quality.

However, the distance between a sheet of a media type and the nozzle of the print head for getting a high quality print may vary per media type, even if the media types have the same thickness, and may be larger than the minimum safety distance.

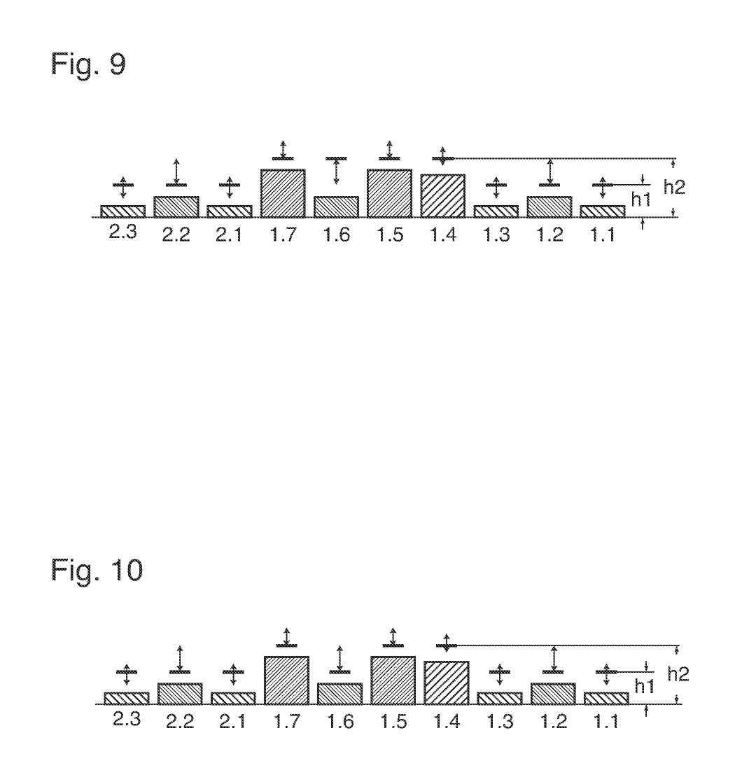

The alternative strategy “adjust on demand” will now be explained by reference to FIG. 4.

An admissible range R for the height h of the print head 12 above the print surface 14 is assigned to each of the sheets and is symbolized in FIG. 4 by a double arrow. As has been shown for the leftmost sheet 3.1, each admissible range R is bounded by a lower limit limₗ and an upper limit limᵤ. Obviously, the lower limit limₗ must always be larger than the thickness of the sheet. Further, a certain safety distance has to be provided in order to reliably prevent a collision of the print head with the sheet. The lower limit limₗ may be different even for sheets which have the same thickness (such as the sheets 1.3 and 1.4), because the expected unevenness of the top surface of the sheet depends upon the sheet material, and the safety distance must be larger when the unevenness of the sheet is expected to be larger.

When the height of the print head above the top surface of the sheet is increased, this means that the droplets ejected from the print head have to travel a larger distance, and the aberration of the droplets in horizontal direction may be larger. The upper limit limᵤ indicates the height that should not be exceeded in order to assure an acceptable print quality. However, since the size of the ink dots formed on the sheet surface will depend upon the properties of the sheet (material or surface coating), the tolerable aberrations of the ink droplets may vary from sheet type to sheet type, and consequently the upper limit limᵤ may vary dependent upon the sheet material.

In order to reduce the number of height adjustment operations per copy that was necessary in FIG. 3, the strategy illustrated in FIG. 4 provides that the height of the print head is adjusted only when the height to which the print head is currently set falls outside of the admissible range R of the sheet to be printed next. In the example shown, this situation occurs only twice for each of the 5-page copies to be printed, i.e. after sheet 1.1 and after sheet 1.5. As a consequence, the number of height adjustment operations is reduced by a factor of 50% in this example and the productivity is increased accordingly.

However, it will be observed that, according to this strategy, the print head may be adjusted to different heights even for one and the same media type. For example, the sheets 1.1 and 1.3 are of the same type, but the print head is nevertheless adjusted to different heights. This may have the consequence that the print quality is slightly different even for media sheets of the same type.

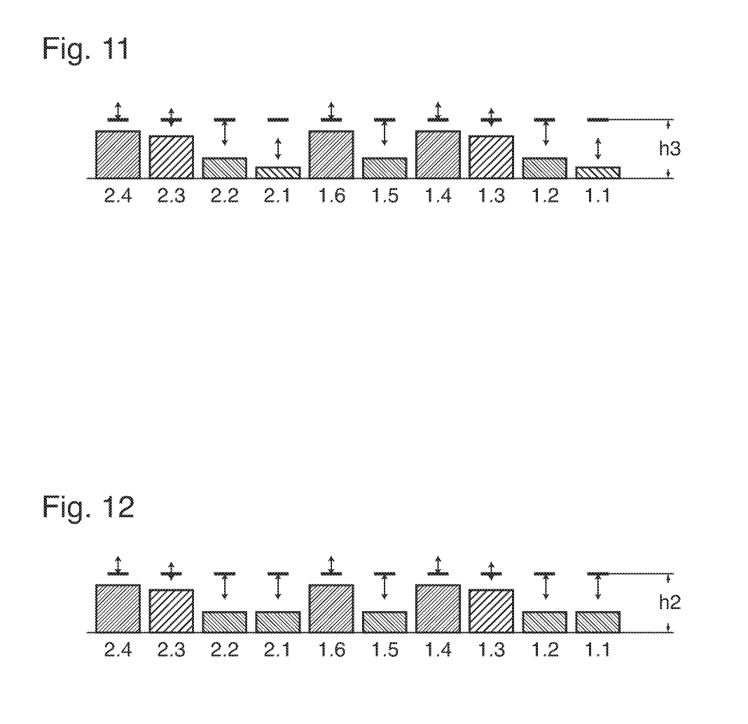

In some cases, this inconsistency in print quality can be avoided and the productivity can be enhanced even further by adopting the strategy “high productivity”, a first example of which has been illustrated in FIG. 5.

The strategy illustrated in FIG. 5 is based on the following principle. The admissible ranges R of all the sheets that are scheduled for printing, at least of all sheets of the given print job, are analysed in order to see whether there is an overlap between the admissible ranges R of the different sheets. In case of a print job that consists in printing multiple copies of a multi-page document, the analysis may be limited to the sheets that form the pages of one copy of the document because the sheet sequence is repetitive and will be the same for each copy of the document.

In the example shown in FIG. 5, fortunately, there is an overlap between the admissible ranges R of all five sheets (e.g. sheets 1.1-1.5) of the document. It is therefore possible to find a height value h1 that is contained in the admissible ranges R for all sheets. The height h of the print head 12 is therefore adjusted to this height value h1, so that it is possible to use a constant height of the print head for the entire job.

More specifically, the height value h1 has been selected to be the lower limit limₗ of the admissible range R for the thickest sheet 1.5 in the job. This will assure that the print quality is as high as is possible without changing the height of the print head.

In practice, there is of course no guarantee that a height value that suits for all pages can always be found. FIG. 6 illustrates an example of a mixed sheet sequence in which such a unique height value does not exist. Although there exists an overlap between the admissible ranges R of the sheets 1.2-1.4, the sheet 1.5 does not fit. The lower limit of its admissible range is larger than the upper limit of the admissible ranges of all the other sheets.

It is possible however to divide the sequence of sheets into two contiguous sub-sequences, one consisting of the sheets 1.1-1.4 and the second one consisting only of the sheet 1.5. Then, a common height value h1 can be selected for the first sub-sequence, and another height value h2 has to be selected for the second sub-sequence (only the sheet 1.5 in this example). In this way, it is at least possible to reduce the number of necessary height adjustment operations to two per copy, i.e. one adjustment operation between the times where the sheets 1.4 and 1.5 are printed, and another one between the times at which the sheets 1.5 and 2.1 are printed.

Productivity may be increased further if it is not required that the pages of the various copies of a document are all printed in the same order, e.g. if the discharge section 20 is capable of re-collating and re-ordering the sheets. For example, if the discharge section 20 includes another sheet reversal mechanism, then the method illustrated in FIG. 6 may be modified as follows.

The first copy of the document, with pages 1.1-1.5, is printed in the same way as in FIG. 6. Then, the second copy with pages 2.1-2.5 is printed with reversed page order, i.e., sheet 2.5 is printed immediately after sheet 1.5, then followed by sheet 2.4, and so on. This has the advantage that the print head is already adjusted to the correct height when the print process proceeds from sheet 1.5 to 2.5. Consequently, the necessary number of height adjustment operations for printing the sheets 1.1-2.5 is reduced from four to two. The sheets 2.1-2.5 will then be reversed in orientation by the sheet reversal mechanism in the discharge section 20 and will be discharged face-down into another bin 22. Consequently, all the copies will be discharged in collated manner, with the only difference that the copies in one bin 22 will be oriented face up and the copies in the other bin face down.

FIG. 7 illustrates an example (of simplex printing) wherein the admissible range for sheet 1.1 overlaps with the admissible range for sheet 1.2, the admissible range for sheet 1.2 overlaps with the admissible ranges for sheets 1.3 and 1.4, but the admissible ranges for 1.1 on the one hand and 1.3 and 1.4 on the other hand do not overlap. Sheet 1.5 is of the same media type as sheet 1.2, and sheet 1.6 is of the same media type as sheet 1.4. The document to be printed has six pages so that sheet 2.1 becomes the first page of the second copy.

In the example shown in FIG. 7, the height of the print head can be kept in the admissible range for all sheets by selecting a height value h1 for the sheets 1.1, 1.2 and 1.5, and a different height value h2 for the sheets 1.3, 1.4 and 1.6. However, this has the consequence that as many as four height adjustment operations per copy are needed.

FIG. 8 illustrates a more efficient printing method for the same print job as in FIG. 7. Here, the first height value h1 has been set to give an optimal print quality for sheet 1.1. This height value h1 can however be used only for the one sheet 1.1. The second height value h2 has been selected to fit in the admissible ranges for all the other sheets 1.2-1.6. This has the consequence that the print quality for sheets 1.2 and 1.5 may not be quite as high as in FIG. 7, but on the other hand the number of necessary height adjustment operations is reduced to only two per copy, so that the productivity is increased significantly. In order to optimize productivity, it should therefore always be attempted to keep the number of sub-sequences in which the sheet sequence has to be split as small as possible.

FIG. 9 shows an example where the document to be printed has seven pages. Sheets 1.1 to 1.3 are printed with the print head set to a first height h1, and then sheets 1.4 to 1.7 are printed with a print head set to a second height h2. The height of the print head is always in the admissible range and only two height adjustment operations per copy are needed, so that the productivity is high. However, a certain drawback is that sheet 1.2 is printed with the print head set to h1 whereas sheet 1.6, which is of the same type, is printed with the print head set to h2, so that there is an inconsistency of the print qualities for sheets of the same type, similarly as in FIG. 3.

In order to avoid this, the user may select the strategy “consistent quality” on the screen 38 shown in FIG. 2. This strategy has been illustrated in FIG. 10. The sequence of sheets is the same as in FIG. 9, but the height adjustment strategy provides that sheets of the same type are always printed with the same height setting. Consequently, after printing sheet 1.5, the print head has to be lowered to h1 for printing sheet 1.6, and then has to be lifted again for printing sheet 1.7. In this strategy, the productivity will consequently be lower, but the consistency of the print quality is preserved.

FIG. 11 illustrates a possible modification of the height adjustment strategy “high productivity” for the same print job as in FIGS. 7 and 8. Here, a maximum productivity is achieved by selecting a single height value h3 for the entire job. This height value h3 fits within the admissible ranges for the sheets 1.2-1.6, but falls out of the admissible range for sheet 1.1, which means that print quality for sheet 1.1 has been sacrificed. The controller 32 may offer this option to the user automatically via the display 36 but should alert the user that this comes at the cost of quality.

FIG. 12 illustrates another modification which can also achieve a maximum productivity for the same print job as in FIGS. 7, 8 and 11. In this strategy, it is proposed to the user to modify the media type instructions in the print job by using a different type of media sheets for page 1, i.e. sheets 1.1, 2.1, etc. In the example shown, the new media type for sheet 1.1 is the same as for sheet 1.2, so that an acceptable print quality can be achieved without any loss in productivity.

The properties of the different types of print media are commonly stored in the form of a data base in a so-called media catalogue which may be stored in the controller 32 or to which the controller has access via a network. The properties stored in the media catalogue permit to determine the admissible range R for each media type. Further, the properties of each media type may be categorized by defining a number of qualities such as color, surface gloss, stiffness, water resistivity and the like, and by assigning a numerical quality parameter to each quality and each media type. Then, by calculating a correlation between the quality parameters for each pair of media types, it is possible to obtain a similarity measure that indicates the extent to which the properties of two different media types are similar.

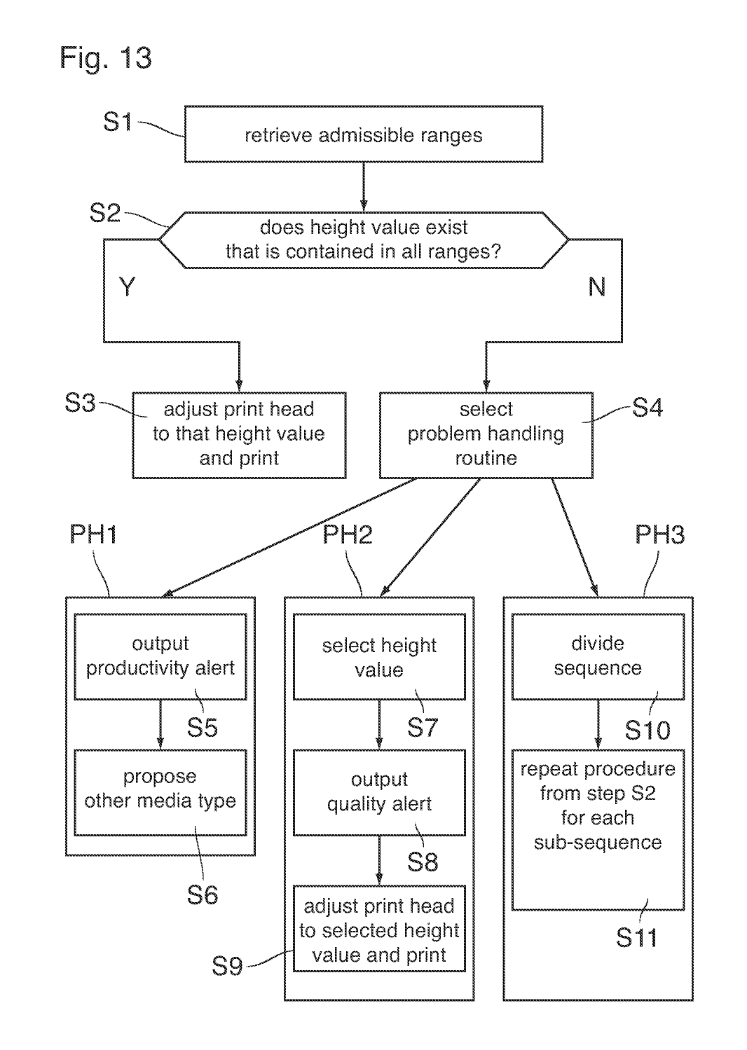

A flow diagram illustrating possible process flows in the strategy “high productivity” embodying the principles described above, has been shown in FIG. 13.

When a sequence of media sheets to be supplied to the print surface 14 has been scheduled by the controller 32, the admissible ranges R for the media types of these sheets are derived from the media catalogue in step S1. The sheets that are considered here may belong to a single duplex or simplex print job but might as well belong to a plurality of print jobs waiting in a print queue for the printer.

Then, it is checked in step S2 whether a unique height value h1 exists that fits for all sheets, i.e. that is contained in the admissible ranges R for all the scheduled sheets. If that is the case, (Y), then the print head 12 is adjusted to that height value h1 in step S3, and the sheets are printed with maximum productivity.

If no such unique height value can be found in step S2 (N), then one of a plurality of predefined problem handling routines PH1, PH2 or PH3 is selected in step S4.

In a simple embodiment, just one problem handling routine PH1 may be available, which simply consists in alerting the user that a loss in productivity must be expected (step S5). Optionally, the loss in productivity may be quantified in the alert, e.g. by indicating the estimated time that will be needed for completing the job and/or by indicating a percentage by which the expected time will exceed the time that would be needed if printing an optimal productivity would be possible. It may then be left to the user to decide whether he accepts the loss in productivity or whether he turns to another printer or modifies his print job.

In the more elaborated embodiment shown here, the step S5 is supplemented by another step S6 in which one or more alternative media types are selected (by reference to the similarity measure) and are proposed to the user, optionally with an indication of the degree of similarity and/or the differences in the properties of the media. Then, the user may decide whether to change the media type as proposed or to print with reduced productivity.

Another possible problem handling routine PH2 starts with a step S7 of selecting a height value that leads to a loss in quality, as in FIG. 11, and outputting a quality alert, in step S8 in which the user is asked whether he is prepared to accept a certain loss in quality. Optionally, the expected loss in quality may be quantified further, based on the difference between the proposed height value (e.g. h3 in FIG. 11) and the upper limit of the admissible range R for the pertinent sheet (sheet 1.1 in FIG. 11).

Then, if the user accepts the loss in quality, the height value h3 that fits for all the other sheets is selected and used for printing in step S9.

Yet another available problem handling routine PH3 attempts, in a step S10, to divide the scheduled sequence of sheets as has been illustrated in any of the FIGS. 6 to 10.

In a subsequent step S11, the procedure starting with step S2 is re-iterated for each of the sub-sequences that have been specified in step S10. If that does not lead immediately to a satisfactory result (step S3), then the step S4 may be repeated for each of the sub-sequences. When the routine PH3 is selected, the step S10 may comprise selecting another possibility to divide the original sequence into two sub-sequences. When all possible divisions of the original sequence have been tested, the step 10 may also comprise dividing the sub-sequences further into sub-sub-sequences.

The decision in step S4 may be automated, based on certain pre-defined criteria. For example, these criteria may specify that the routine PH1 is selected if the expected loss in productivity is relatively small and/or can be avoided by selecting a media type that is very similar to the type that was originally intended. Further, these criteria may specify that the routine PH2 is selected if the expected loss in productivity would be large but the expected loss in quality would be relatively small. Further, the criteria may specify that the routine PH3 is selected if the criteria for none of the other routines PH1 and PH2 are met.

It will be understood that at least one of the criteria that are checked in step S4 may be set or modified by the user, so that the user may for example give highest priority to productivity or highest priority to quality, or specify a certain minimum quality level.

What is claimed, is:

1. A printer that is adapted for printing on a mixed sequence of media sheets with a print head that is adjustable in height relative to a print surface that supports the media during printing, the printer having a user interface and a controller arranged to control a height adjustment mechanism for the print head, wherein the controller stores a set of different height adjustment strategies for handling media that differ in specifications that define an admissible range for the height of the print head, said height adjustment strategies being different from one another in that they permit each a different productivity of the print process, and the user interface is adapted to permit the user to select among the stored height adjustment strategies.

2. The printer according to claim 1, wherein one of the height adjustment strategies comprises setting the height of the print head for each media sheet to a value that is optimized in terms of print quality for that media sheet.

3. The printer according to claim 1, wherein one of the height adjustment strategies includes adjusting the height of the print head only on condition that the height to which the print head is presently set is outside of an admissible range (R) for the height of the print head for the next media sheet to be printed.

4. The printer according to claim 1, wherein one of the height adjustment strategies comprises the steps of:
(a) retrieving admissible height ranges for a plurality of media sheets that are scheduled for printing,
(b) searching for a height value that is contained in the admissible range of all scheduled sheets,
(c1) if such a height value is found, adjusting the print head to that height value,
(c2) if not, proceeding to a problem handling routine.

5. The printer according to claim 4, wherein the problem handling routine, comprises a step of alerting a user of the printer of an expected productivity loss.

6. The printer according to claim 4, wherein the problem handling routine comprises a step of identifying a media type of at least one of the scheduled sheets that has an admissible range that does not overlap with the admissible ranges for the other scheduled sheets, selecting, from a set of predefined media types, another media type that has an admissible range that does overlap with the admissible ranges of the other sheets, and proposing to a user of the printer to replace the identified media type by the selected one.

7. The printer according to claim 4, wherein the problem handling routine includes the step of selecting a height value that fits in the admissible range for a majority of scheduled sheets but exceeds an upper limit of an admissible range for at least one sheet, and a step of alerting a user of the printer of an expected loss in quality.

8. The printer according to claim 4, wherein the problem handling routine includes a step of dividing the sequence of scheduled sheets into two continuous sub-sequences, and a step of searching, for each of the two sub-sequences, for a height value that is contained in the admissible range of all sheets of the sub-sequence.

9. A non-transitory software product containing program code, that, when run on a controller of a printer that is adapted for printing on a mixed sequence of media sheets with a print head that is adjustable in height relative to a print surface that supports the media during printing, the printer having a user interface and said controller, implements the features according to claim 1 in the printer.
